(19) United States
(12) Patent Application Publication
(10) Pub. No.: US 2018/0123161 A1
(43) Pub. Date: May 3, 2018

(54) SECONDARY BATTERY

(71) Applicant: CONTEMPORARY AMPEREX TECHNOLOGY CO., LIMITED, Ningde City (CN)

(72) Inventors: Chengyou XING, Ningde City (CN); Jian GUO, Ningde City (CN)

(21) Appl. No.: 15/657,396

(22) Filed: Jul. 24, 2017

(30) Foreign Application Priority Data
Nov. 1, 2016 (CN) 201610952458.6

(51) Int. Cl. H01M 10/04

(52) U.S. Cl. CPC H01M 10/0459; H01M 2220/20; H01M 10/0413

(57) ABSTRACT

A secondary battery, including a first terminal, a second terminal, a first electrode plate, a second electrode plate, a first connecting piece and a second connecting piece, the first terminal, the first connecting piece and the first electrode plate together form a current path, the second terminal, the second connecting piece and the second electrode plate together form a current path; At least one of the first and second connecting piece is provided with a fuse device which includes a first and a second fuse part, the first and second fuse part are connected in series to the current path where the fuse device is, the first and second fuse part respectively has a smaller cross-sectional area than that of adjacent domains, the first and second fuse part are spaced from each other, and the first fuse part has the same cross-sectional area as the second fuse part does.

### CROSS-REFERENCE TO RELATED APPLICATIONS

The present application claims priority to Chinese Patent Application No. 201610952458.6, filed on Nov. 1, 2016, the content of which is incorporated herein by reference in its entirety.

### TECHNICAL FIELD

The present application relates to the technical field of energy storage device and, particularly, to a secondary battery.

### BACKGROUND

With the increasing perfection of the electric vehicle technologies, electric vehicles and hybrid vehicles are getting closer and closer to people's daily life. Moreover, people have higher requirements on the safety performance of the power battery, which acts as the power source of the electric vehicles and the hybrid vehicles. Generally, a power battery includes multiple secondary batteries, and each of the secondary batteries includes a case, a terminal exposed outside the case and an electrode assembly accommodated in the case. The terminal and the electrode assembly are electrically connected with each other through a connecting plate. The connecting plate is provided with a notch along a direction of the current, so that a cross-sectional area at this region is smaller than a cross-sectional area of an adjacent region, and, as a result, it can service as a fuse device and be timely fused in case of an overcurrent.

However, in order to guarantee the strength of the connecting plate of the existing secondary battery, the notch is usually made small and only one notch is provided, when the current reaches 1000-8000 A, the voltage reaches 20-48V, the connecting plate will be fused at the notch position. When the fuse device is melted, an arc may be generated between separated parts, causing that the interior of secondary battery is still conductive, and this will result in time extension for interrupting the current, thereby increasing the potential safety risks of the secondary battery.

### SUMMARY

The present application provides a secondary battery, so as to overcome the problems mentioned as above.

The present application provides a secondary battery, including: an electrode assembly, the electrode assembly includes a first electrode plate, a second electrode plate and a separator between the first electrode plate and the second electrode plate, the secondary battery also includes a first terminal, a second terminal, a first connecting piece and a second connecting piece, wherein the first terminal is electrically connected with the first electrode plate through the first connecting piece, and the second terminal is electrically connected with the second electrode plate through the second connecting piece;

the first connecting piece is provided with a fuse device, the fuse device includes a first fuse part and a second fuse part, the first fuse part and the second fuse part are connected in series and between the first terminal and the first electrode; and/or the second connecting piece is provided with a fuse device, the fuse device comprises a first fuse part and a second fuse part, the first fuse part and the second fuse part are connected in series and between the second terminal and the second electrode plate;

each of the first fuse part and the second fuse part has a cross-sectional area smaller than a cross-sectional area of an adjacent region, the first fuse part and the second fuse part are spaced from each other, and the cross-sectional area of the first fuse part is identical to the cross-sectional area of the second fuse part.

Preferably, a first through hole is provided in a central area of at least one of the first fuse part and the second fuse part.

Preferably, at least one side wall of the first fuse part is provided with a notch, and/or at least one side wall of the second fuse part is provided with a notch.

Preferably, either a size of the first fuse part or a size of the second fuse part is not less than 2 mm.

Preferably, the fuse device is shaped in a sheet structure, a thickness of at least one of the first fuse part and the second fuse part is smaller than a thickness of the adjacent region.

Preferably, a distance between the first fuse part and the second fuse part is at least 5 mm.

Preferably, a portion of the first connecting piece between the first fuse part and the second fuse part is provided with a second through hole; and/or a portion of the second connecting piece between the first fuse part and the second fuse part is provided with a second through hole.

Preferably, the secondary battery further comprises a first insulating unit, the first insulating unit covers the first fuse part and/or the second fuse part.

Preferably, the first insulating unit is a plastic insulating piece.

Preferably, the secondary battery further comprises a short-circuit member and a top cover plate, the short-circuit member is attached to the top cover plate, the first terminal is electrically connected with the top cover plate, the second terminal is insulated from the top cover plate, when an internal pressure of the secondary battery exceeds a reference pressure, the short-circuit member deforms to form an electrical connection path passing through the first electrode plate, the first terminal, the top cover plate, the short-circuit member, the second terminal and the second electrode plate.

The technical solution provided by the present application can achieve the following beneficial effects:

In the secondary battery provided by the present application, by arranging the first fuse part and second fuse part to be connected in series and spaced from each other, the first fuse part and the second fuse part can be fused at the same time when the current reaches 1000-8000 A, the voltage reaches 20-48V, even if an arc is generated, due to the existence of two disconnections, a metal grid-plate structure is formed between the two disconnections, so that the arc is cut into several short arcs at the position of the metal grid-plate structure, and thus the arc extinguishing effect is improved, which makes the current of the secondary battery be interrupted as soon as possible, and thus reduce potential safety risks.

It should be understood that both the above general description and the following detailed description are only examples and cannot limit the scope of the present application.

### BRIEF DESCRIPTION OF DRAWINGS

FIG. 1 is a structural schematic diagram of a secondary battery provided by an embodiment of the present application;

FIG. 2 is a partial structural schematic diagram of a secondary battery provided by an embodiment of the present application;

FIG. 3 is a front view of a fuse device in a secondary battery provided by an embodiment of the present application;

FIG. 4 is a cross-sectional view along line A-A in FIG. 3;

FIG. 5 is a structural schematic diagram of a fused fuse device shown in FIG. 3;

FIG. 6 is a cross-sectional view along line B-B in FIG. 5;

FIG. 7 is a front view of a fuse device in a secondary battery provided by another embodiment of the present application;

FIG. 8 is a schematic diagram of a fuse device in a secondary battery provided by another embodiment of the present application;

FIG. 9 is an exploded view of a fuse device in a secondary battery provided by another embodiment of the present application;

FIG. 10 is a schematic diagram of a fuse device in a secondary battery provided by another embodiment of the present application; and

FIG. 11 is another partial structural schematic diagram of a secondary battery provided by an embodiment of the present application.

### REFERENCE SIGNS

10—case;

11—top cover plate;

20—first terminal;

30—second terminal;

31—conductive structure;

40—first connecting piece;

41—first fuse part;

411—first through hole;

412—notch;

42—second fuse part;

43—assembling hole;

44—avoiding hole;

45—electric arc;

46—second through hole;

50—second connecting piece;

60—first electrode plate;

70—second electrode plate;

80—first insulating unit;

90—short-circuit member.

The drawings herein are incorporated into and constitute a part of the present specification, which show the embodiments of the present application and illustrate the principles of the present application together with the specification.

### DESCRIPTION OF EMBODIMENTS

The present application will be further illustrated clearly and completely with reference to the drawings and specific embodiments.

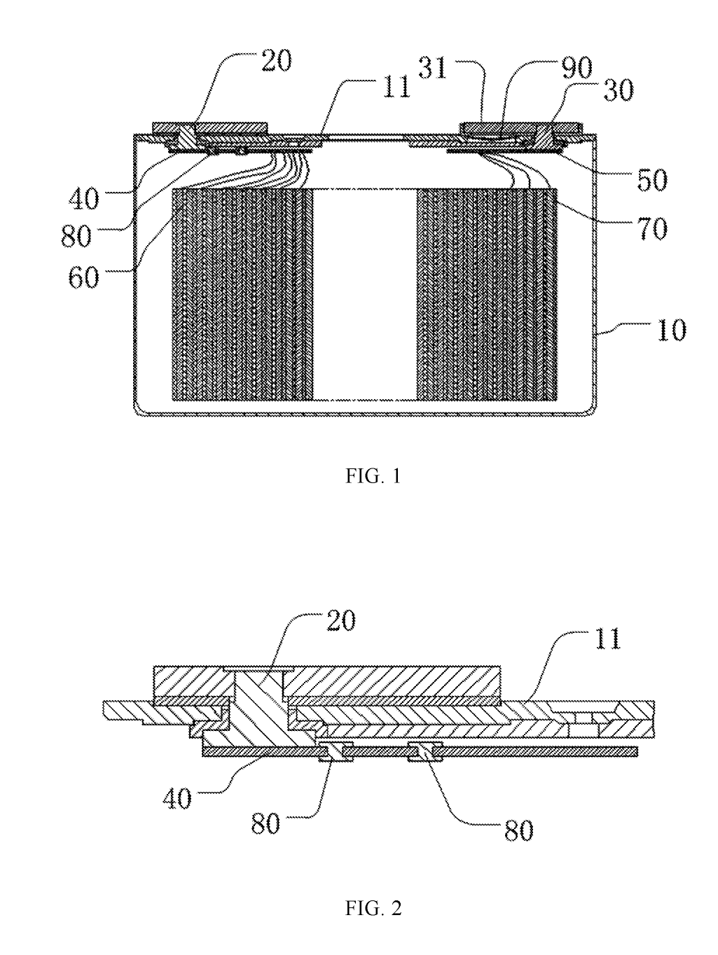

As shown in FIGS. 1-2, a secondary battery provided by an embodiment of the present application includes a first terminal 20, a second terminal 30, an electrode assembly, a first connecting piece 40 and a second connecting piece 50. Generally, the secondary battery also includes a case 10. The electrode assembly includes a first electrode plate 60, a second electrode plate 70 and a separator between the first electrode plate 60 and the second electrode plate 70.

The first terminal 20 can be a positive terminal (i.e., the first electrode plate 60 is a positive electrode plate), correspondingly, the second terminal 30 can be a negative terminal (i.e., the second electrode plate 70 is the negative electrode plate). Likewise, the first terminal 20 can also be a negative terminal (i.e., the first electrode plate 60 is a negative electrode plate), and the second terminal 30 can also be a positive terminal (i.e., the second electrode plate 70 is a positive electrode plate).

The first terminal 20 and the second terminal 30 extend out of the case 10, so as to be electrically connected with external environment. The first electrode plate 60, the second electrode plate 70, the first connecting piece 40 and the second connecting piece 50 are installed in the case 10. Specifically, the first terminal 20, the first connecting piece 40 and the first electrode plate 60 form a current path, while the second terminal 30, the second connecting piece 50 and the second electrode plate 70 also form a current path.

At least one of the first connecting piece 40 and the second connecting piece 50 is provided with a fuse device, that is, both the first connecting piece 40 and the second connecting piece 50 can be provided with a fuse device, or only one of the first connecting piece 40 and the second connecting piece 50 can be provided with a fuse device. The fuse device will be described in detail as below by an example of providing a fuse device in the first connecting piece 40, and the arrangement of fuse device in the second connecting piece 50 can be referred to any of the embodiments below.

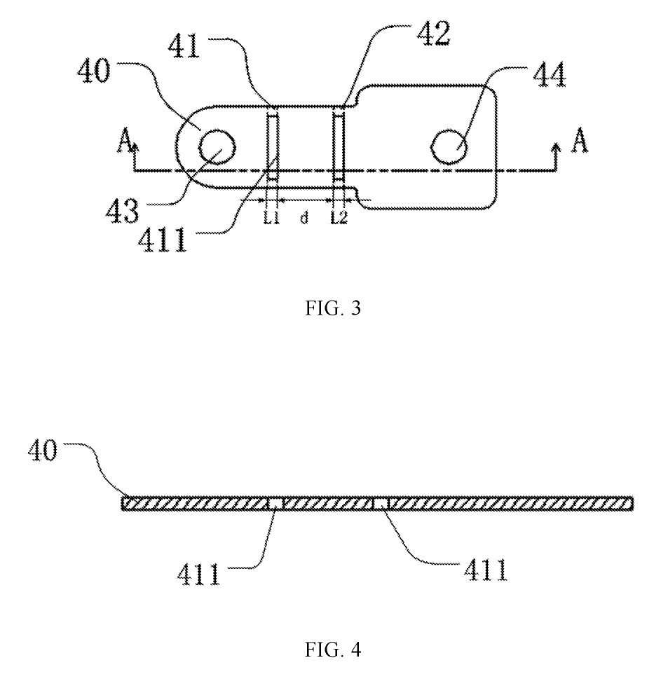

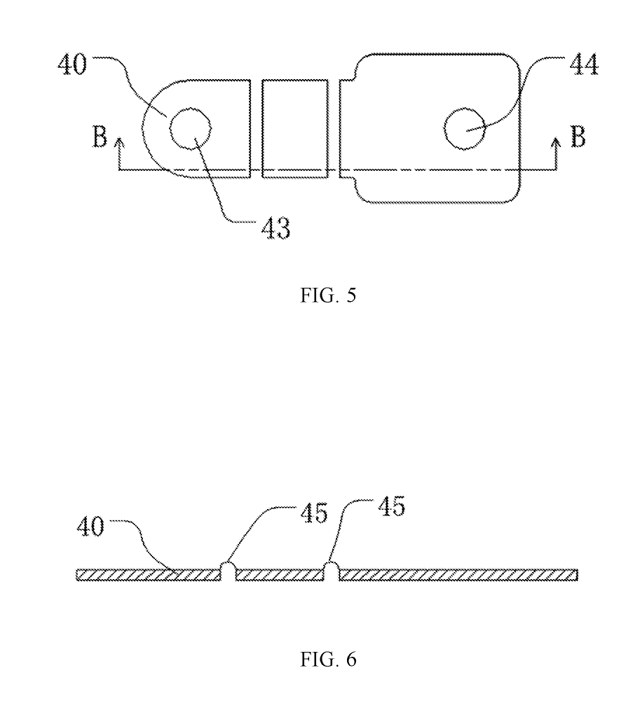

As shown in FIGS. 3-10, the fuse device includes a first fuse part 41 and a second fuse part 42, as shown in FIG. 3, both the first fuse part 41 and the second fuse part 42 are shaped in a strip structure, a length direction of the first fuse part 41 and the second fuse part 42 is perpendicular to the direction of the current in the current path, and they both include an area surrounded by the first through hole 411 and the dash lines located at both ends of the first through hole 411. The first fuse part 41 and the second fuse part 42 are connected in series into the current path where the fuse device is located, to be specific, the first fuse part 41 and the second fuse part 42 are connected in series and between the first terminal and the first electrode plate or between the second terminal and the second electrode plate. The first fuse part 41 and second fuse part 42 respectively has a cross-sectional area smaller than a cross-sectional area of an adjacent region, that is, the cross-sectional area of either the first fuse part 41 or the second fuse part 42 is smaller than the cross-sectional area of the rest portion of the first connecting piece 40, and the first fuse part 41 and the second fuse part 42 are spaced from each other. The first fuse part 41 has the same cross-sectional area with the second fuse part 42, so that the first fuse part 41 and the second fuse part 42 can be fused at the same time. Meanwhile, it is guaranteed that, the first fuse part 41 and second fuse part 42 are fused first rather than other portions.

In the above embodiments, by arranging the first fuse part 41 and second fuse part 42 to be connected in series and spaced from each other, the first fuse part 41 and the second fuse part 42 can be fused at the same time when the current reaches 1000-8000 A, the voltage reaches 20-48V, even if an arc is generated, as shown in FIG. 6, due to the existence of two disconnections, a metal grid-plate structure is formed between the two disconnections, so that the electric arc 45 is cut into several short arcs at the position of the metal grid-plate structure, and thus the arc extinguishing effect is improved, which makes the current of the secondary battery be interrupted as soon as possible, and thus reduce potential safety risks.

One or more first fuse parts 41 and one or more second fuse parts 42 can be provided, each first fuse part 41 and each second fuse part 42 are spaced from each other and are connected in series in the current path where the fuse device is located. When a plurality of the first fuse parts 41 and a plurality of the second fuse parts 42 are provided, since a relatively large disconnection area, especially a relatively large area of a metal grid-plate structure, is formed when malfunction occurs, a better arc extinguishing effect will be achieved.

The first fuse part 41 and the second fuse part 42 can respectively be provided in any one of the manners shown as below.

In a first manner, a first through hole 411 is provided in the central area of at least one of the first fuse part 41 and the second fuse part 42, as shown in FIG. 3 and FIG. 8, the fuse device breaks at the position of first through hole 411 along the current direction in the current path where the fuse device is located. By providing the first through hole 411, the cross-sectional area of the first fuse part 41 or the second fuse part 42 can be reduced, and then the fusing time of the first fuse part 41 or the second fuse part 42 can be reduced. Preferably, the first fuse part 41 and the second fuse part 42 are both provided with the first through hole 411, so as to further reduce the possibility of generation of an arc. Specifically, the two first through holes 411 are spaced from each other to strengthen the fuse device. Of course, the two first through holes 411 can also be communicated with each other or, instead, a larger through hole can be provided, however, in this manner, the strength of the fuse device will be influenced.

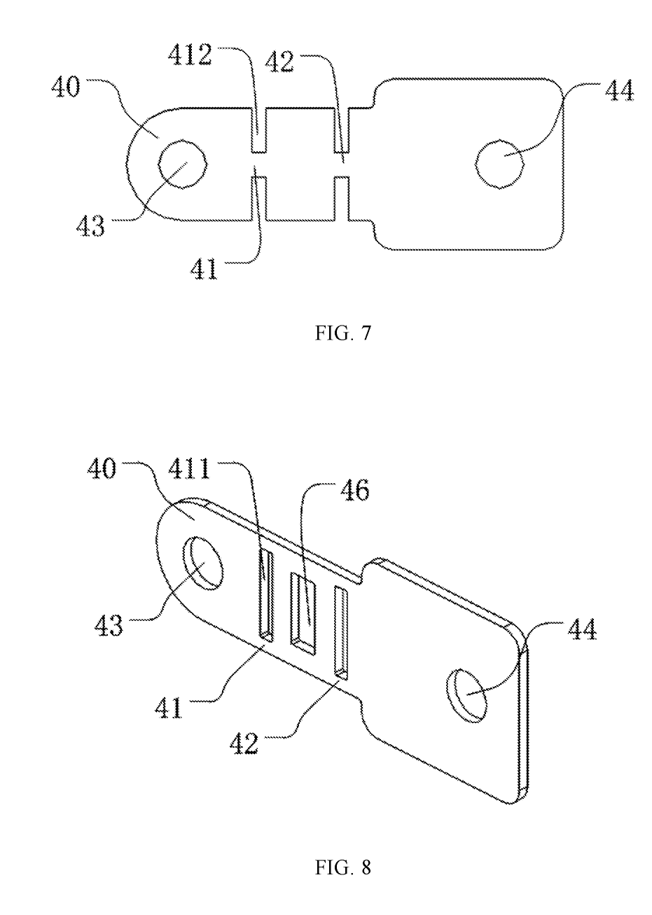

In a second manner, at least one side wall of the first fuse part 41 is provided with a notch 412, and at least one side wall of the second fuse part 42 is provided with a notch 412, as shown in FIG. 7, it is also possible that only one of the first fuse part 41 and the second fuse part 42 is provided with a notch 412.

In a third manner, when the fuse device is a sheet-shaped structure, the thickness of at least one of the first fuse part 41 and the second fuse part 42 is smaller than a cross-sectional area of an adjacent region, a groove, such as an U-shaped groove, can be set on the fuse device, usually the U-shaped groove penetrates through the fuse device in its own extending direction which is parallel to the sheet-shaped structure and perpendicular to the current direction. Of course, when the thickness of the first fuse part 41 and the second fuse part 42 is smaller than that of the other portions, the fuse device can also be block-shaped or other structures.

Since the arc extinguishing effect is influenced by the distance between the first fuse part 41 and the second fuse part 42, in order to achieve a better arc extinguishing effect, usually the distance (d in FIG. 3) between the first fuse part 41 and the second fuse part 42 along the current direction will be at least 5 mm, such as 5 mm, 8 mm, 10 mm.

In order to further increase the arc extinguishing effect, the portion of the first connecting piece between the first fuse part 41 and the second fuse part 42 is also provided with a second through hole 46, as shown in FIGS. 8-10, more preferably, the size of the second through hole 46 along the current direction is larger than the size of the first fuse part 41 and the size of the second fuse part 42, so as to reduce the area that may generate electric arcs 45.

Since the size (L1 in FIG. 3) of the first fuse part 41 and the size (L2 in FIG. 3) of the second fuse part 42 are too small along the current direction in the current path where the fuse device is located, and the arc phenomenon is more serious, the size of the first fuse part 41 and the size of second fuse part 42 are generally not less than 2 mm. When the first fuse part 41, the second fuse part 42 are provided with the first through hole 411 or the notch 412, along the current direction, the size of the first fuse part 41 and the size of the second fuse part 42 size will be too large, which will weaken the strength of the fuse device. As a result, the size of the first fuse part 41 and the size of the second fuse part 42 are usually selected as 2 mm, of course, due to manufacturing errors, the size may be made more than 2 mm, such as 2.1 mm, 2.2 mm.

In addition, the fuse device is also provided with an assembling hole 43 and an avoiding hole 44, the assembling hole 43 is configured for positioning when assembling the first terminal 20 or the second terminal 30. Since the case 10 is provided with a liquid injection hole, the avoiding hole 44 is arranged opposite to the injection hole so that, when injecting electrolyte, the electrolyte can flow smoothly into the interior of the secondary battery.

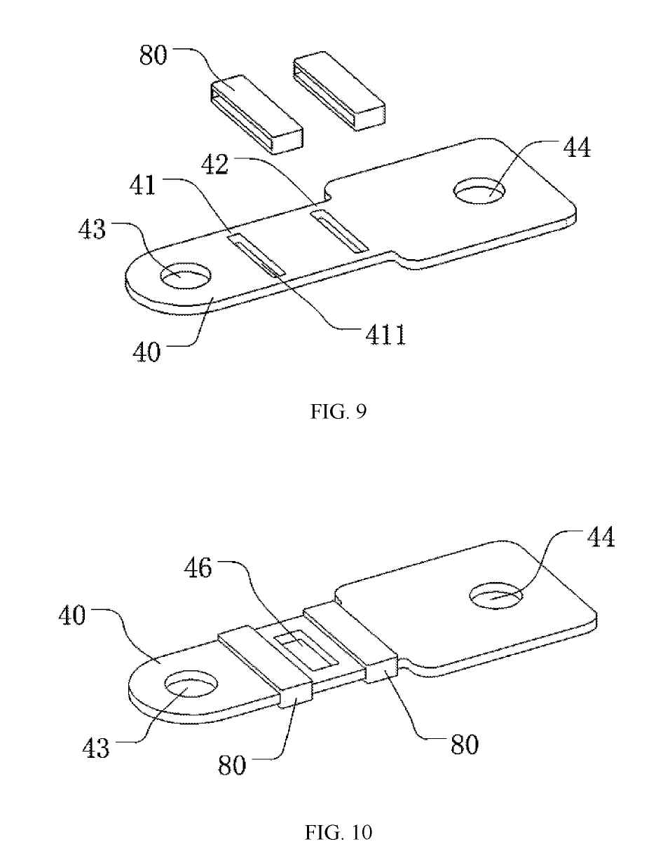

As shown in FIGS. 9-10, the secondary battery also includes a first insulating unit 80, the first insulating unit 80 covers the first fuse part 41 and the second fuse part 42. With the first insulating unit 80, after the first fuse part 41 or the second fuse part 42 is fused, due to being covered by the first insulating unit 80, only the insulated section is exposed, thereby reducing the area where the electric arc 45 may be generated, and improving the arc extinguishing effect. Of course, it is possible that only one of the first fuse part 41 and the second fuse part 42 is provided with the first insulating unit 80.

When the first fuse part 41 and the second fuse part 42 are provided with the first through hole 411, the secondary battery also includes a second insulating unit, the second insulating unit is arranged in the first through hole 411, and when the first fuse part 41 or the second fuse part 42 is fused, the second insulating unit can increase the insulation effect between components on two sides of the first through hole 411, thereby further improving the arc extinguishing effect, when the second insulating unit is connected with the fuse device, they are usually integrated as a whole structure by injection molding, so as to increase the strength of the fuse device.

The material of the first insulating unit 80 and the second insulating unit can respectively be selected from at least one of the materials such as asbestos, cotton linen, plastic and the like. Particularly, the material of the first insulating unit 80 is preferably a plastic insulation piece, since the melting point of the plastic material is relatively low, under the high temperature of the fusing, the first insulating unit 80 is gasified, the electrons in the fusing area are blown away, so as to reduce the possibility of generation of an arc, thereby improving the safety performance of the secondary battery.

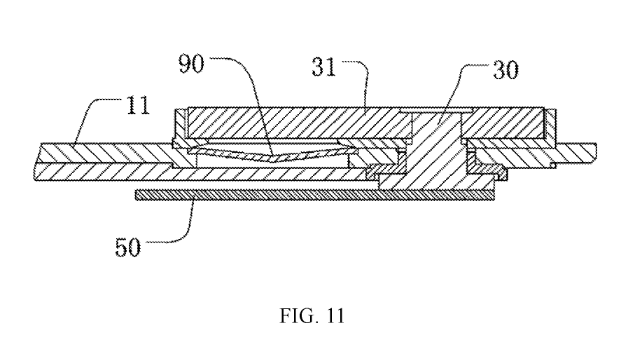

In order to achieve overcharging protection for the battery, the secondary battery also includes a short-circuit member 90, the case 10 includes a top cover plate 11, as shown in FIG. 1 and FIG. 11, the short-circuit member 90 is attached to the top cover plate 11. In a normal state, the short-circuit member 90 can make the first terminal 20 be electrically insulated from the second terminal 30, and when an internal pressure of the secondary battery exceeds a reference pressure, the short-circuit member 90 can make the first terminal 20 be electrically connected with the second terminal 30.

Further, as shown in FIG. 11, the secondary battery also includes a conductive structure 31, the first terminal 20 is electrically connected with the top cover plate 11, the first terminal 20 and the top cover plate 11 can be electrically connected by directly attached to each other, or by a transition piece. Generally, the second terminal 30 is electrically insulated from the top cover plate 11 by an insulating piece. The top cover plate 11 is provided with a connection hole which communicates the interior with the exterior of the secondary battery.

The conductive structure 31 is at arranged outside the case 10, and is electrically connected with the second terminal 30, that is, the second terminal 30 is connected with the conductive structure 31, and the conductive structure 31 is electrically insulated from the top cover plate 11 while the conductive structure 31 is opposite to the connection hole.

The short-circuit member 90 is usually a deformable plate which seals the connection hole, a periphery of the short-circuit member is electrically connected with the top cover plate 11. The short-circuit member 90 is electrically insulated from the conductive structure 31 in a normal state, and when the internal pressure of the secondary battery exceeds the reference pressure, the short-circuit member 90 deforms so that the short-circuit member 90 is electrically connected with the conductor structure 31. With the conductive structure 31, the short-circuit member 90 can be electrically connected with the second terminal 30 as soon as possible after deforming, so as to reduce risks resulted from overcharging. Of course, the short-circuit member 90 can also be electrically connected with the second terminal 30 by other structures when the internal pressure of the secondary battery exceeds the reference pressure.

The above description only shows preferred embodiments of the present application and is not intended to limit the present application. Various replacements and modifications may be made by those skilled in the art. Any modifications, equivalent replacements, improvements and the like made within the spirit and principles of the present application should be included in the protection scope of the present application.

What is claimed is:

1. A secondary battery, comprising: an electrode assembly, the electrode assembly comprises a first electrode plate, a second electrode plate and a separator between the first electrode plate and the second electrode plate, wherein the secondary battery further comprises a first terminal, a second terminal, a first connecting piece and a second connecting piece, the first terminal is electrically connected with the first electrode plate through the first connecting piece, and the second terminal is electrically connected with the second electrode plate through the second connecting piece;
the first connecting piece is provided with a fuse device, the fuse device comprises a first fuse part and a second fuse part, the first fuse part and the second fuse part are connected in series and between the first terminal and the first electrode plate; and/or the second connecting piece is provided with a fuse device, the fuse device comprises a first fuse part and a second fuse part, the first fuse part and the second fuse part are connected in series and between the second terminal and the second electrode plate;
each of the first fuse part and the second fuse part has a cross-sectional area smaller than a cross-sectional area of an adjacent region, the first fuse part and the second fuse part are spaced from each other, and the cross-sectional area of the first fuse part is identical to the cross-sectional area of the second fuse part.

2. The secondary battery according to claim 1, wherein a first through hole is provided in a central area of at least one of the first fuse part and the second fuse part.

3. The secondary battery according to claim 1, wherein at least one side wall of the first fuse part is provided with a notch, and/or at least one side wall of the second fuse part is provided with a notch.

4. The secondary battery according to claim 1, either a size of the first fuse part or a size of the second fuse part is not less than 2 mm.

5. The secondary battery according to claim 1, wherein the fuse device is shaped in a sheet structure, a thickness of at least one of the first fuse part and the second fuse part is smaller than a thickness of the adjacent region.

6. The secondary battery according to claim 1, a distance between the first fuse part and the second fuse part is at least 5 mm.

7. The secondary battery according to claim 1, wherein a portion of the first connecting piece between the first fuse part and the second fuse part is provided with a second through hole, and/or a portion of the second connecting piece between the first fuse part and the second fuse part is provided with a second through hole.

8. The secondary battery according to claim 1, wherein the secondary battery further comprises a first insulating unit, the first insulating unit covers the first fuse part and/or the second fuse part.

9. The secondary battery according to claim 8, wherein the first insulating unit is a plastic insulating piece.

10. The secondary battery according to claim 1, wherein the secondary battery further comprises a short-circuit member and a top cover plate, the short-circuit member is attached to the top cover plate, the first terminal is electrically connected with the top cover plate, the second terminal is insulated from the top cover plate, when an internal pressure of the secondary battery exceeds a reference pressure, the short-circuit member deforms to form an electrical connection path passing through the first electrode plate, the first terminal, the top cover plate, the short-circuit member, the second terminal and the second electrode plate.
